(19) United States
(12) Patent Application Publication
(10) Pub. No.: US 2007/0044603 A1
(43) Pub. Date: Mar. 1, 2007

(54) Automated de-strapper

(76) Inventors: William John Scholtes, Pascoe Vale South (AU); Craig Norman Bryant, Vermont (AU); Shane Gerard Bowden, Toolernvale (AU); Trevor Henry Craven, South Yarra (AU)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/210,921

(22) Filed: Aug. 24, 2005

(51) Int. Cl. B26D 1/00

(52) U.S. Cl. 83/13; 83/72

(57) ABSTRACT

An apparatus for destrapping a load L constrained by multiple straps S, comprising a manipulating arm 1 carrying a working head 2 including photoelectric means 3, 17, 18 for locating one of the multiple straps S, irrespective of its orientation relative to the load, means 9,10 for engaging the strap S and means 6 for cutting the strap S while engaged to release the strap from the load, said strap being partly engaged by the engaging means 9 or 10 for removal of the strap for disposal, said manipulating arm operating under the control of a programmable controller C to perform said locating, engaging and cutting of the strap S.

### BACKGROUND

Palletised loads are required to be contained by the provision of straps of plastic or metal surrounding the load and engaging the pallet. When the palletised load is ready for unloading, the straps must be removed. The removal operation is usually performed by an operator, and that results in increased costs to the enterprise and increased risk of injury to the operator.

The patent literature includes examples of destrapping machines, the most relevant of which is DE 19812575 Kuemmerer et al. This document discloses a system which cuts a strap and removes it using a gripper on the opposite side of a strapped load to the cutter. Similarly, in US 2004194428 Close et al, a single strap around a sleeved product is cut and removed by a suction system.

In neither of the above examples is the machine capable of locating and cutting multiple straps which may run in different directions around a load

There is therefore a need for a destrapping apparatus which is able operate to achieve the above without operator intervention.

### SUMMARY

In one aspect the invention provides an apparatus for destrapping a load constrained by multiple straps, comprising a manipulating arm carrying a working head including means for locating one of the multiple straps, irrespective of its orientation relative to the load, means for engaging the strap and means for cutting the strap while engaged to release the strap from the load, said manipulating arm operating under the control of a programmable controller to perform said locating, engaging and cutting of the strap.

The apparatus defined above enables the destrapping of loads such as palletised loads largely without operator intervention, and the programmable means allows the machine to be used with loads of various types and dimensions having multiple straps positioned in different orientations relative to the pallet or its direction of travel on a conveyor, usually across the palletised load in both directions.

The apparatus may include means for holding the cut strap after it has been cut to enable the cut strap to be removed from the load for disposal. In one form the apparatus includes a chopper or shredder for converting the cut strap into small recyclable pieces.

The means for locating a strap may include one or more optical or photoelectric means for locating at least one part of the strap. The optical or photoelectric means may be located adjacent the cutting means or the engaging means so that the cutting means is operable to cut the strap while engaged.

In one embodiment, a photoelectric strap locator is positioned on either side of the cutting means so that the strap is located to be in the cutting region of the cutting means when the strap is located by both optical strap locators. A further photoelectric or other suitable device may be positioned on the head to enable the top of the palletised load to be located before the strap locators are operated to locate the straps.

The means for engaging the strap may include a clamp for securely clamping the strap when it has been located to prevent undesirable movement of the strap while it is being cut. In one embodiment, the working head carries a pair of clamps, one on either side of the cutting means.

The means for engaging the strap may include a structure which gathers the strap as the head moves over the strapped load to enable the locating means to identify that a strap has been located. In one embodiment a structure of this sort is associated with each optical strap locator and each clamp.

The controller can be programmed to locate one portion of the strap within one of the gathering structures and to turn the head until the other of the gathering structures locates another portion of the strap whereupon the clamps are operated to clamp the strap and the strap is cut.

When the strap is cut, the controller releases one of the clamps and the head is moved to locate the cut strap in a position for disposal.

If desired the de-strapper may include further optical or other means for determining the presence of one or more straps on the load, the further means being used to check that all straps have been removed from the load.

To ensure that the straps are more easily located, the top of the palletised load may include a top frame which spaces the straps about 10 mm from the top of the load.

Other features of the apparatus will be described further below.

In another aspect, there is provided a method of destrapping a load secure by a plurality of straps arranged in different orientations with respect to the load, comprising the steps of (a) locating a predetermined portion of a strapped load, (b) locating one of the plurality of straps on the load, (c) engaging the strap against undesired movement, (d) cutting the strap, (e) removing the strap from the load while it remains at least partially engaged, (f) releasing the strap from engagement for disposal, and (g) repeating steps (b) to (g) until all straps are removed.

The method may be performed using the apparatus defined above, step (b) and (c) including locating a portion of one strap, engaging that portion, moving the locating means until another portion of the same strap is located, and engaging the other portion of the strap.

Desirable features of the method will be apparent from the following description.

### BRIEF DESCRIPTION OF THE DRAWINGS

In the drawings:

FIG. 1 is an isometric view of an automated de-strapper embodying the invention.

FIG. 2 is a front elevation of the operative head of the de-strapper.

FIG. 3 is a side elevation of the head of FIG. 2.

### DESCRIPTION OF EMBODIMENT

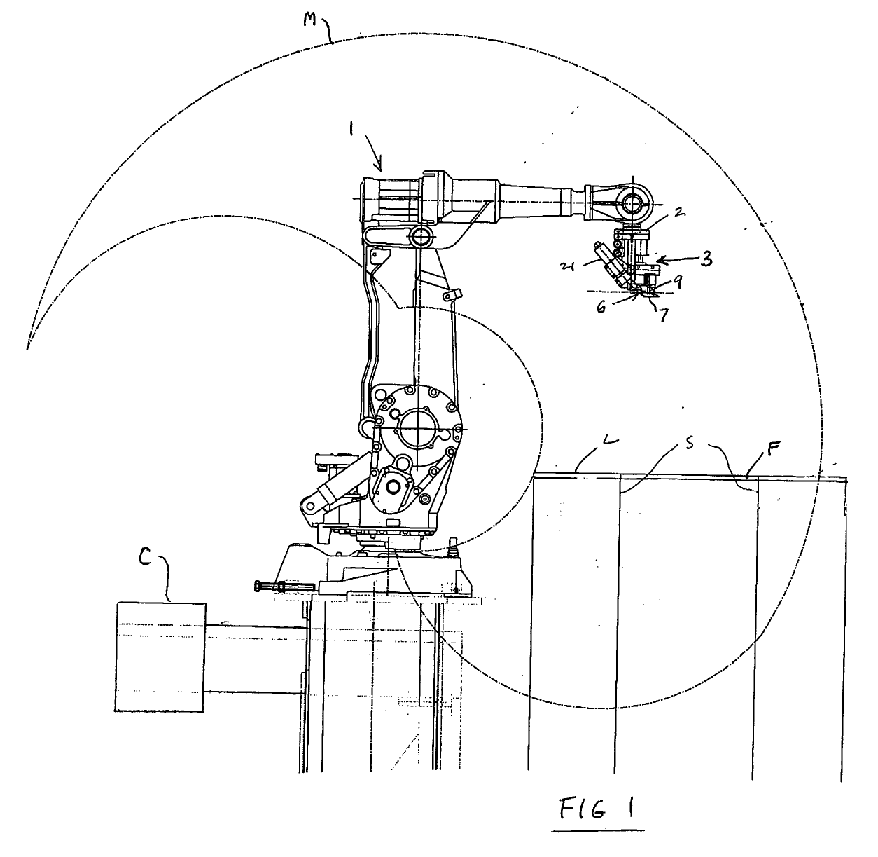

The strap removal apparatus shown in the drawings is designed to automatically remove plastic or metal straps or hold down bands from palletised loads of goods such as beverage containers. Loads, such as L in FIG. 1, typically include a wooden, plastic or wound corrugated base pallet (not shown), layers of containers and tie or slip sheets (not shown), and a wooden or plastic top frame F. Plastic banding or straps S are looped under the pallet deck board and over the top frame F, which is present to ensure that the straps are spaced about 10 mm from the top of the palletised load. There may be up to four straps in each direction of the load, depending on the product.

Referring to FIG. 1 of the drawings, the strap removal apparatus includes a robotic arm 1, in the present case an ABB IRB 2400/16 M2000 six axis robot manufactured by The ABB Group. Since the robot arm is a proprietary item of known characteristics, it will not be described further. The movement of the arm 1 is under the control of a programmable controller C shown schematically in FIG. 1, which is pre-programmed in a known manner, such as instructed by the manufacturer of the arm 1, with instructions to suit the dimensions of the pallet and the load L, as well as the number of and approximate positions of the straps S. There may be four or five straps S for removal and they are located in a predetermined pattern parallel and/or perpendicular to the direction of the conveyor (not shown) for transporting the palletised load to the robot arm 1. The straps are suitably spaced by at least 100 mm to allow them to be located.

The rotary head 2 of the robot 1 carries a destrapping tool 3 embodying the invention. The head 2 can rotate through 360 deg while the robot arm can swivel in either direction to position the tool 3 in any desired position relative to a palletised load L having straps S requiring removal, as illustrated. In FIG. 1 the field of movement of the robot arm 1 is schematically illustrated by the broken line M.

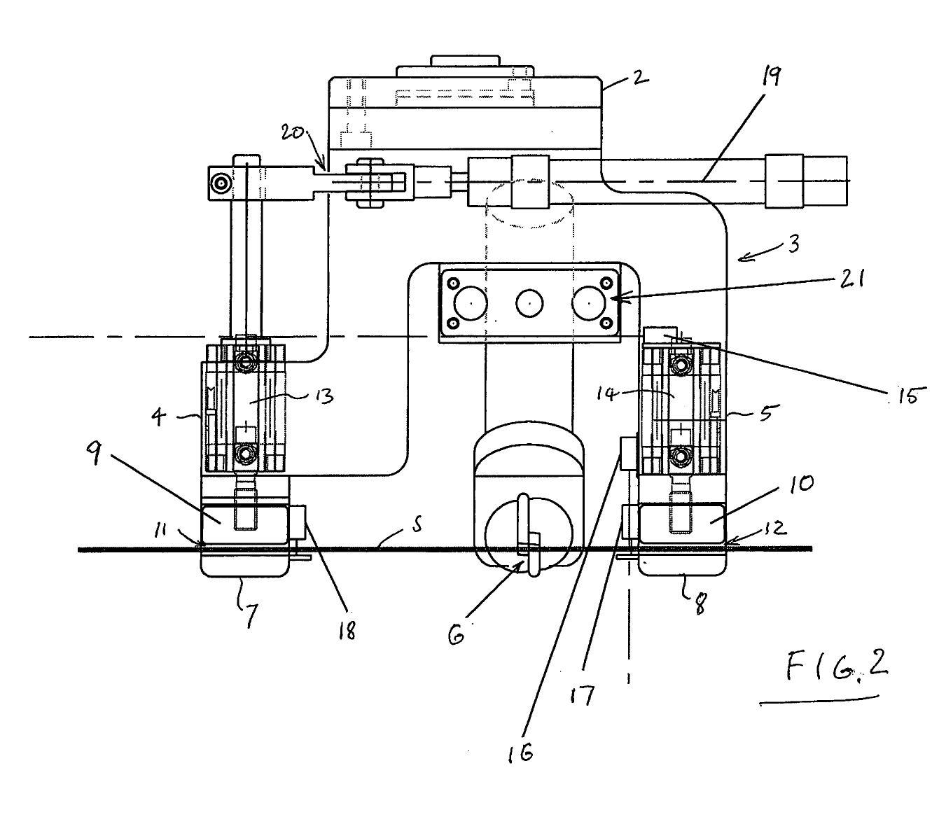

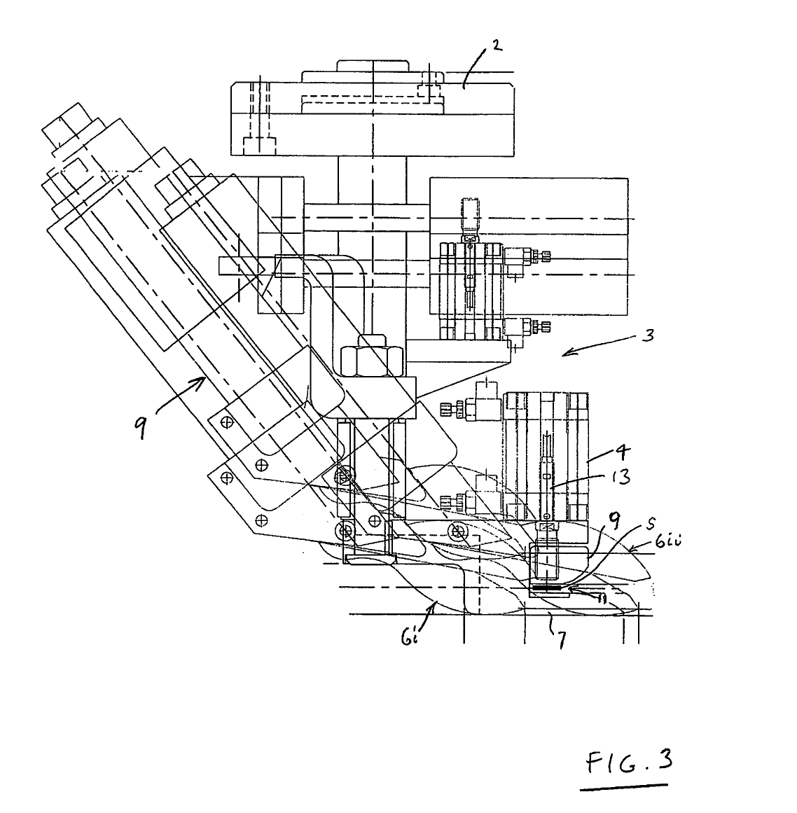

Referring to FIGS. 2 and 3, the destrapping tool 3 includes a pair of spaced depending strap locating legs 4 and 5, between which is positioned a strap cutter 6, which is movable between the positions illustrated in FIG. 3, through the line of strap S when located as illustrated, during the cutting operation. Each leg has a lower foot portion 7, 8, which is designed to engage under the strap S during the strap locating operation, in the position illustrated in FIGS. 2 and 3. Spaced above each foot 7, 8 are clamping anvils 9, 10 which are spaced from each respective foot as illustrated to create strap receiving gaps 11, 12. When the strap S has been located as shown, the anvils 9,10 are actuated by cylinders 13,14 to clamp the strap S in position for the cutting operation.

The tool 3 includes four photoelectric sensors 15 to 18 positioned as shown to locate the top and an edge of the palletised load L and the straps S. Sensor 15 finds the position of the top of the load L while sensor 16 finds the position of one edge of the load L from which the tool 3 commences its search for the straps S at the top of the load L. Sensor 16 has a fixed sensing range and the tool 3 is moved to within 5 to 10 mm of the top of the load L to locate the straps S.

The sensors 17 and 18 find one of the straps S, the robot 1 moving the tool 3 until the strap S is located in one of the gaps 11 or 12 where it is detected by one of the sensors 17 or 18. The arm 1 is then rotated until the other of the sensors 17 or 18 detects the presence of the strap S within the other of the gaps 11 or 12. The strap is then clamped by the clamps 9 and 10 and the cutter 6 actuated to cut the strap S. During the cutting operation, the cutter 6 moves through the location of the strap as illustrated, by means of cutter extend cylinder 21. The cutter extend cylinder 21 is then retracted and the clamp 10 released, at which time the robot 1 moves the tool 3 and the strap S still clamped by the clamp 9 to a position for disposal of the strap S.

As the strap is removed, the tool 3 is rotated by the cylinder 19 and linkage 20 to present the strap S to a strap chipper or shredder (not shown) located adjacent the robot 1. The chipper is activated and the robot moves towards the chipper to feed the strap S into the chipper, whereupon the clamp 9 is released and the strap is taken into the chipper for disposal and recycling. The robot then moves away, deactivating the cylinder 19, and repeats the strap locating steps to locate and cut the next strap S.

Following location and cutting of all straps S, the palletised load L is moved away and the next load L presented to the robot 1 for destrapping.

It will be appreciated that sensors other than the photoelectric sensors shown may be used with acceptable results, for example laser or tactile sensors. Similarly the cutter may take other form such as those disclosed in the prior art documents detailed above. The robot arm may also take any suitable form known in the packaging industry.

We claim:

1. An apparatus for destrapping a load constrained by multiple straps, comprising a manipulating arm carrying a working head including means for locating one of the multiple straps, irrespective of its orientation relative to the load, means for engaging the strap and means for cutting the strap while engaged to release the strap from the load, said manipulating arm operating under the control of a programmable controller to perform said locating, engaging and cutting of the strap.

2. The apparatus of claim 1, wherein the means for engaging the strap includes means for holding the cut strap after it has been cut to enable the cut strap to be removed from the load for disposal.

3. The apparatus of claim 1 or 2, wherein the apparatus includes a chopper or shredder for converting the cut strap into small recyclable pieces.

4. The apparatus of claim 2, wherein the means for locating a strap may include one or more optical or photoelectric means for locating at least one part of the strap.

5. The apparatus of claim 4, wherein the optical or photoelectric means is located adjacent the cutting means or the engaging means so that the cutting means is operable to cut the strap while engaged.

6. The apparatus of claim 4 or 5, wherein a said strap locator is positioned on either side of the cutting means so that the strap is located to be in the cutting region of the cutting means when the strap is located by both strap locators.

7. The apparatus of claim 4, 5 or 6, wherein a further photoelectric or other suitable locator device is positioned on the head to enable the top of the load to be located before the strap locators are operated to locate the straps.

8. The apparatus of claim 1 or 2, wherein the means for engaging the strap includes a clamp for securely clamping the strap when it has been located to prevent undesirable movement of the strap while it is being cut.

9. The apparatus of claim 8, wherein the working head carries a pair of clamps, one on either side of the cutting means.

10. The apparatus of claim 8, wherein the means for engaging the strap includes a structure which gathers the strap as the head moves over the strapped load to enable the locating means to identify that a strap has been located.

11. The apparatus of claim 10, wherein a said structure is associated with each strap locator and each clamp.

12. The apparatus of claim 11, wherein the controller is programmed to locate one portion of the strap within one of the gathering structures, and to turn the head until the other of the gathering structures locates another portion of the same strap, whereupon the clamps are operated to clamp the strap and the strap is cut.

13. The apparatus of claim 12, wherein when the strap is cut, the controller releases one of the clamps and the head is moved to locate the cut strap in a position for disposal.

14. The apparatus of claim 1 wherein the load includes a top frame member which spaces the straps from the top of the load.

15. A method of destrapping a load secure by a plurality of straps arranged in different orientations with respect to the load, comprising the steps of (a) locating a predetermined portion of a strapped load, (b) locating one of the plurality of straps on the load, (c) engaging the strap against undesired movement, (d) cutting the strap, (e) removing the strap from the load while it remains at least partially engaged, (f) releasing the strap from engagement for disposal, and (g) repeating steps (b) to (g) until all straps are removed.

16. The method of claim 15, wherein the method is apparatus defined in claim 1, step (b) and (c) including the steps of locating a portion of one strap, engaging that portion, moving the locating means until another portion of the same strap is located, and engaging the other portion of the strap.
